(19) United States
(12) Patent Application Publication
(10) Pub. No.: US 2018/0032461 A1
(43) Pub. Date: Feb. 1, 2018

(54) CONTROL CIRCUIT BOARD, MICRO-SERVER, CONTROL SYSTEM AND CONTROL METHOD THEREOF

(71) Applicants: INVENTEC (PUDONG) TECHNOLOGY CORPORATION, Shanghai City (CN); INVENTEC CORPORATION, Taipei City (TW)

(72) Inventor: Song ZHANG, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 15/260,174

(22) Filed: Sep. 8, 2016

(30) Foreign Application Priority Data
Jul. 26, 2016 (CN) 201610595158.7

(51) Int. Cl. G06F 13/40; G06F 13/42

(52) U.S. Cl. CPC G06F 13/4022; G06F 13/4221

(57) ABSTRACT

A control system includes a host device, a plurality of computing nodes of micro-servers, a first switch and a first processor. The first switch is electrically connected to the plurality of computing nodes of micro-servers and the host device. The first processor is electrically connected to the plurality of computing nodes of micro-servers, the host device and the first switch. The first processor is configured to process a first GPIO signal provided by the host device and generate a first control command according to the result of processing the first GPIO signal. The first processor selectively turns on the data path from the first switch to one of the plurality of computing nodes of micro-servers and sends a second GPIO signal to one of the plurality of computing nodes of micro-servers.

### CROSS-REFERENCE TO RELATED APPLICATIONS

This non-provisional application claims priority under 35 U.S.C. §119(a) on Patent Application No(s). 201610595158.7 filed in China on Jul. 26, 2016, the entire contents of which are hereby incorporated by reference.

### BACKGROUND

### Technical Field

The disclosure relates to a control circuit board, a micro-server, a control system and a control method thereof, and more particularly to a control circuit board, a micro-server, a control system and a control method thereof applied to an inter-integrated circuit (I²C) bus.

### Related Art

An I²C bus is a common serial communication bus. In the 1980s, Philips developed it for connecting a host device with micro-servers and peripheral devices. Equipments on the I²C serial communication mainly appear in master-slave architecture, including master unit and slave unit. Both master unit and slave unit are able to send and receive data. For conventional system design, one master unit can be connected to many slave units, such as baseboard management controllers. Different slave units have their own unique addresses so the master unit must communicate with different slave units by different addresses. Besides, these addresses are written in the slave units and have relative firmware visions respectively. The more slave units there are, the more addresses and their relative firmware visions there are. For example, when a master unit is connected to twenty slave units and every slave units has own unique address, twenty firmware versions are needed. As a result, the development costs of hardware and software must increase.

### SUMMARY

One embodiment in the disclosure provides a control circuit board, a micro-server, a control system and a control method thereof in order to make a host device able to communicate with one of the plurality of baseboard management controllers selectively through the setup of processors and switches.

According to an embodiment, the disclosure provides a control circuit board including a host device, the first switch and the first processor. The host device provides the first general purpose input/output (GPIO) signal. The first switch is electrically connected to the host device and the first processor is electrically connected to the first switch and the host device. The first processor is configured to process the first GPIO signal, generate the first control command according to the result of processing the first GPIO signal, and selectively conduct the data path from the first switch to one of the multiple computing nodes of a micro-server according to the first control command.

In an embodiment, the result of processing the first GPIO signal includes a code. The first processor distinguishes one of the plurality of computing nodes and generates the first control command according to the code.

According to an embodiment, the disclosure provides a micro-server including multiple computing nodes. Each computing node includes multiple baseboard management controllers, the second switch and the second processor. The second switch is electrically connected to the baseboard management controllers of computing nodes and the second processor is electrically connected to the second switch. The second processor is configured to process the second GPIO signal, generate the second control command according to the result of processing the second GPIO signal, and selectively conduct a data path from the second switch to one of the multiple baseboard management controllers.

In an embodiment, the result of processing the second GPIO signal includes a code. The second processor distinguishes one of the plurality of baseboard management controllers and generates the second control command according to the code.

According to an embodiment, the disclosure provides a control system including a host device, multiple computing nodes of micro-servers, the first switch and the first processor. The host device provides the first general purpose input/output (GPIO) signal. The first switch is electrically connected to the multiple computing nodes and the host device. The first processor is electrically connected to the multiple computing nodes, the host device and the first switch. The first processor is configured to process the first GPIO signal, generate the first control command according to the result of processing the first GPIO signal, selectively conduct the data path from the first switch to one of the multiple computing nodes according to the first control command and send the second GPIO signal to the selected computing node. Besides, the computing node includes multiple baseboard management controllers, the second switch and the second processor. The second switch is electrically connected to the multiple baseboard management controllers and the first switch. The second processor is electrically connected to the first processor and the second switch. The second processor is configured to process the second GPIO signal, generate the second control command according to the result of processing the second GPIO signal, and selectively conduct a data path from the second switch to one of the multiple baseboard management controllers.

In an embodiment, the result of processing the first GPIO signal includes a code. The first processor distinguishes one of the plurality of computing nodes of micro-servers and generates the first control command according to the code. The result of processing the second GPIO signal includes the code. The second processor distinguishes one of the plurality of baseboard management controllers and generates the second control command according to the code.

According to an embodiment, the disclosure provides a control method applied to multiple computing nodes of micro-servers, each of which includes multiple baseboard management controllers. The control method includes following steps: selecting one of the multiple computing nodes; providing the first GPIO signal according to the selected computing node; processing the first GPIO signal and generating the first command according the result of processing the first GPIO signal; and conducting the data path from the first switch to the selected computing node and delivering the second GPIO signal to the selected computing node by a electrical path.

In an embodiment, the above control method further includes following steps: processing the second GPIO signal and generating a second command according a result of processing the first GPIO signal; and selectively conducting a data path from the second switch to one of the plurality of baseboard management controllers.

In an embodiment, the result of processing the first GPIO signal includes a code. The first processor distinguishes the selected computing node and generates the first control command according to the code, the result of processing the second GPIO signal includes the code, the second processor distinguishes one of the plurality of baseboard management controllers and generates the second command according the code.

In view of the above control circuit board, micro-server, control system and control method in one embodiment in the disclosure, through the changeover of the switches by the processors, the host device can be connected to one of the multiple baseboard management controllers selectively and communicate with it.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a system architecture diagram of a control system in an embodiment;

FIG. 2 is a process flow chart of a control method in an embodiment;

FIG. 3 is a process flow chart of a control method in another embodiment;

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

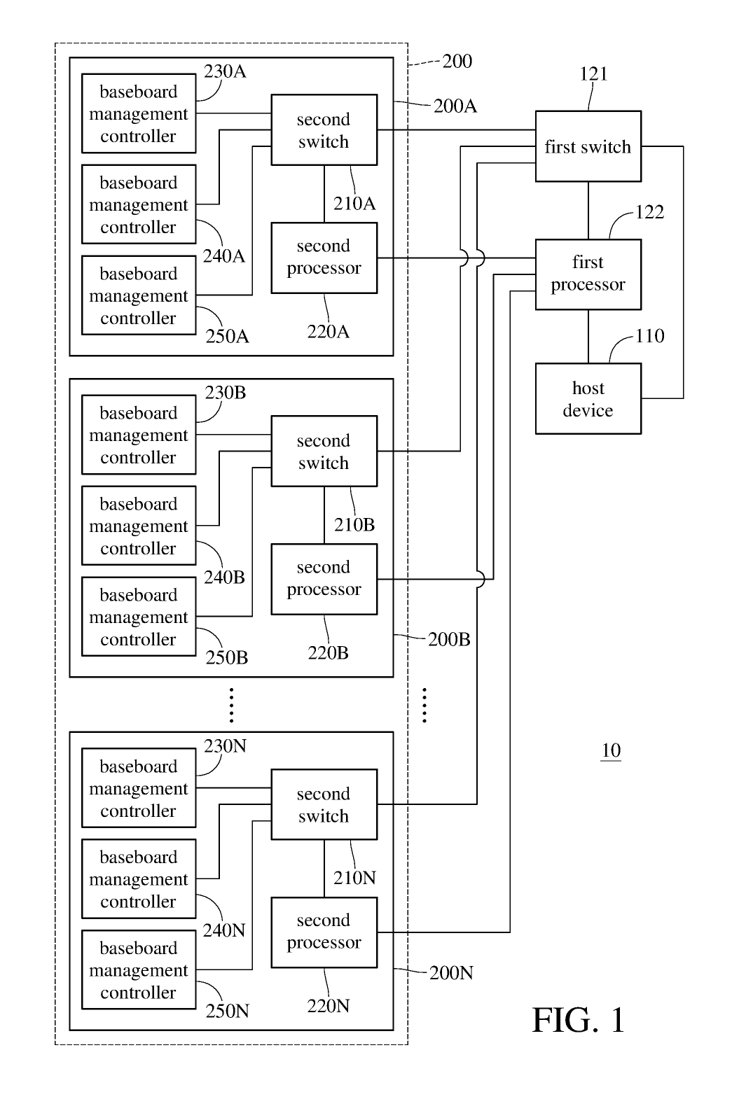

Please refer to FIG. 1. FIG. 1 is a system architecture diagram of a control system in an embodiment. In FIG. 1, a control system 10 includes a host device 110, the first switch 121, the first processor 122 and multiple computing nodes 200A˜200N of micro-server 200. The host device 110 provides the first GPIO signal. In an embodiment, the host device 110, the master unit of I²C bus of computer system, is configured to control multiple slave units. The computing node 200A includes the second switch 210A, the second processor 220A and baseboard management controllers 230A, 240A and 250A. The second switch 210A is electrically connected to the baseboard management controllers 230A, 240A and 250A, and the second switch 210A. In an embodiment, the baseboard management controllers 230A, 240A and 250A are the slave units of I²C bus of computer system and controlled by the host device 110, the master unit. The computing nodes 200B-200N have the same architecture as the computing node 200A so the details of them will not be repeated hereinafter. In an embodiment, the control system 10 includes multiple computing nodes of micro-servers. The disclosure has no limitation in the number of computing nodes.

The first switch 121 is electrically connected to the computing nodes 200A˜200N and the host device 110. In an embodiment, the first switch 121, a kind of electronic components, is used to conduct a circuit to make a current flow through the circuit, or shut off the circuit to make the current stop flowing through the circuit or flow through another circuit. More specifically, the first switch 121 is electrically connected to the computing nodes 200A˜200N. Through the changeover of the internal switch of the first switch 121, the first switch 121 can conduct the data path from the first switch 121 to one of the computing nodes 200A˜200N to make the host device 110 send data to the computing nodes 200A and 200B.

The first processor 122 is electrically connected to the computing nodes 200A˜200N, the host device 110 and the first switch 121. The first processor 122 is configured to process the first GPIO signal and generate the first control command according to the result of processing the first GPIO signal. In an embodiment, the first processor 122 is a programmable logic device composed of multiple logic gates. It is applied to process various kinds of operation and combination logic, such as complex programmable logic device (CPLD). The first processor 122 processes the first GPIO signal by its operation function. According to the generated first control command, the first processor 122 selectively conducts the data path from the first switch 121 to one of the computing nodes 200A, 200B. In other words, according to the first control command generated from the result of processing the first GPIO signal, the first processor 122 can selectively conduct the data path from the first switch 121 to the computing node which the host device 110 is to access to make the host device 110 send data to that computing node.

In an embodiment, when the first processor 122 conducts the first switch 121 to the computing node the host device 110 is to access, the first processor 122 send the second GPIO signal to one of the computing nodes further by a electrical path. More specifically, if the first processor 122 conducts the data path from the first switch 121 to the computing node 200A, the first processor 122 will send the second GPIO signal to the computing node 200A by an electrical path. If the first processor 122 conducts the data path from the first switch 121 to the computing node 200B, the first processor 122 will send the second GPIO signal to the computing node 200B via the electrical path.

In a practical example, if the host device 110 is to access the baseboard management controller 240A of the computing node 200A, the host device 110 will send the first GPIO signal to the first processor 122 first. Next, the first processor 122 processes the first GPIO signal and generates the first control command according to the processing result. Then, the first processor 122 conducts the data path from the first switch 121 to the computing node 200A according to the first control command and sends the second GPIO signal to the computing node 200A by an electrical path. The second processor 220A of the computing node 200A processes the second GPIO signal from the first processor 122 and generates the second control command according to the processing result. The second processor 220A conducts the data path from the second switch 210A to the baseboard management controller 240A to make the host device 110 able to send data to the baseboard management controller 240A.

In an embodiment, the first processor 122 processes the first GPIO signal, and the processing result includes a code. The first processor 122 distinguishes one of multiple computing nodes and generates the first control command according to the code. In other words, according to the code generated by the processing result of the first GPIO signal, the first processor 122 can get the information of the computing node the host device 110 is to access. For example, if the host device 110 is to access the computing node 200A, the host device 110 will send the first GPIO signal to the first processor 122. Next, the first processor 122 processes the first GPIO signal. The processing result includes a code related to the computing node 200A. Then, by the code, the first processor 122 can distinguish that the computing node the host device 110 is to access is the computing node 200A further. Likewise, if the host device 110 is to access the computing node 200B, by the code included in the result of processing the first GPIO signal, the first processor 122 will distinguish that the computing node which the host is to access is the computing node 200B.

In a practical example, if the host device 110 is to access the computing node 200B, the first processor 122 will process the first GPIO signal. After that, according to the code included in the result of processing the first GPIO signal, the first processor 122 can distinguish the computing node 200B and generate the first control command. Then, the first control command generated by the first processor 122 changes the internal switch of the first switch 121 to the computing node 200B to conduct the data path from the first switch 121 to the computing node 200B. At this moment, due to the conducted path between the host device 110 and the computing node 200B, the host device 110 can send data to the baseboard management controller of the computing node 200B.

In another embodiment, besides the fact that the result of processing the first GPIO signal includes the code, the result of processing the second GPIO signal also includes the code. In FIG. 1, when the second processor 220A of the computing node 200A receives the second GPIO signal, the second processor 220A will process the second GPIO signal and the processing result will include the code. Then, the second processor 220A distinguishes one of the baseboard management controllers 230A-250A and generates the second control command by the code. More specifically, according to the code generated by the result of processing the second GPIO signal, the second processor 220A can get the information of the baseboard management controller the host device 110 is to access.

For example, if the host device 110 is to access the baseboard management controller 230A of the computing node 200A, the first processor 122 will conduct the computing node 200A. Then, the first processor 122 sends the second GPIO signal to the computing node 200A further by the electrical path. When the second processor 220A of the computing node 200A receives the second GPIO signal, the second processor 220A will process the second GPIO signal. The second processor 220 distinguishes the baseboard management controller 230A and generates the second control command according to the code included in the result of processing the second GPIO signal. This code is related to the baseboard management controller 230A of the computing node 200A. The second control command generated by the second processor 220A changes the internal switch of the second switch 210A to the baseboard management controller 230A to conduct the data path from the second switch 210A to the baseboard management controller 230A. At this moment, the host device 110 can send data to the baseboard management controller 230A of the computing node 200A.

For another example, if the host device 110 is to access the baseboard management controller 230B of the computing node 200B, the first processor 122 will conduct the computing node 200B. Then, the first processor 122 sends the second GPIO signal to the computing node 200B further by the electrical path. When the second processor 220B of the computing node 200B receives the second GPIO signal, the second processor 220B will process the second GPIO signal. The second processor 220 distinguishes the baseboard management controller 230B and generates the second control command according to the code included in the result of processing the second GPIO signal. This code is related to the baseboard management controller 230B of the computing node 200B. The second control command generated by the second processor 220B changes the internal switch of the second switch 210B to the baseboard management controller 230B to conduct the data path from the second switch 210B to the baseboard management controller 230B. The code included in the result of processing the first GPIO signal is the same as the code included in the result of processing the second GPIO signal, and is related to the baseboard management controller the host device 110 is to access.

According to the description of embodiment above, when the host device 110 is to access the baseboard management controller of the computing node, the first processor 122 will conduct the data path from the first switch 121 to the computing node which is to access. Then, the second processor of the computing node conducts the path data from the second switch to the baseboard management controller which is to access. At this moment, the host device 110 controls the baseboard management controller of the computing node which is to access. In other words, by the first processor 122 selectively conducting the data path from the first switch 121 to the computing node which is to access and the second processor selectively conducting the second switch to the baseboard management controller of the computing node which is to access. Therefore, the host device 110 can send data to any baseboard management controller of any computing node.

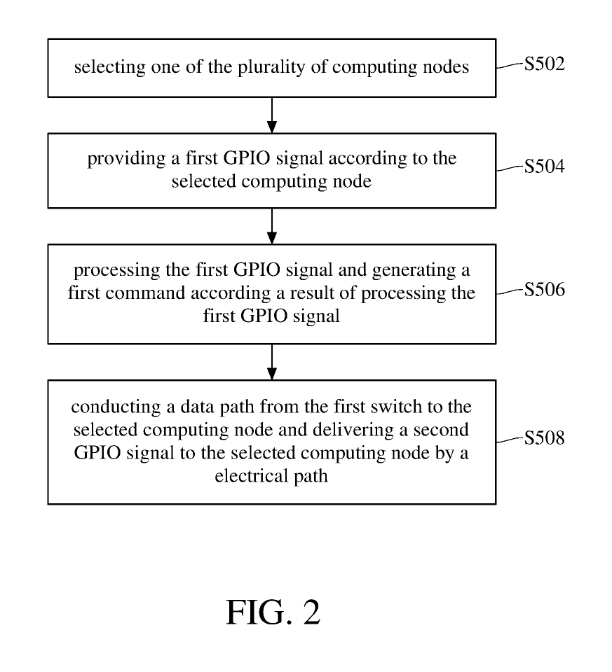

Please refer to FIG. 1 and FIG. 2. FIG. 2 is a process flow chart of a control method in an embodiment. The control method in FIG. 2 is applied to the multiple computing nodes 200A˜200N of the micro-server 200 in FIG. 1. As shown in FIG. 2, the control method includes following steps. In step S502, the host device 110 selects one of multiple computing nodes 200A˜200N. In step S504, the host device 110 provides the first GPIO signal to the first processor 122 according to the selected computing node. In step S506, the first processor 122 processes the first GPIO signal, and generates the first control command according to the result of processing the first GPIO signal. In step S508, the first processor 122 conducts the data path from the first switch 121 to the selected computing node according to the first control command, and sends the second GPIO signal to the selected computing node via the electrical path.

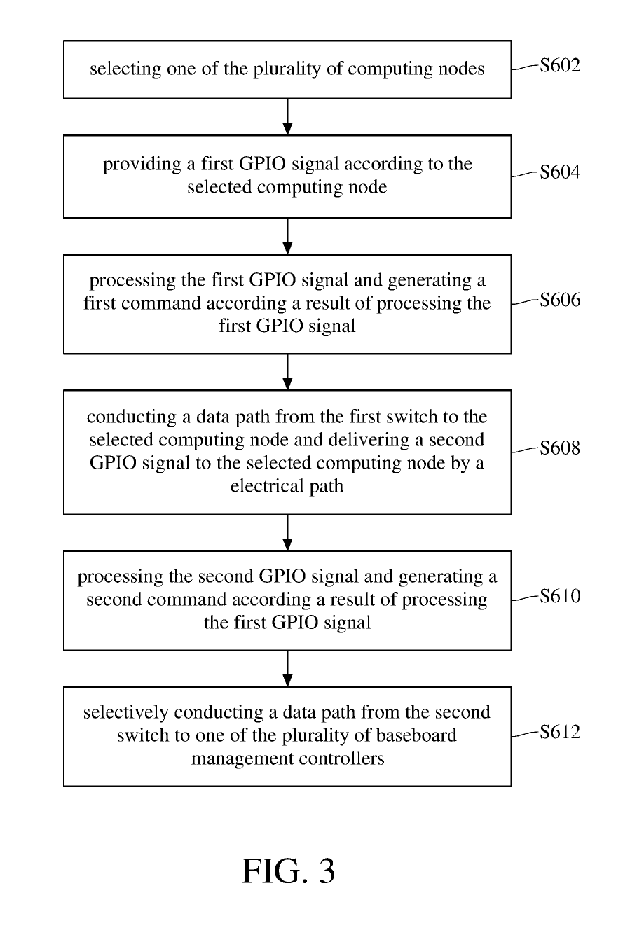

Please refer to FIG. 1 and FIG. 3. FIG. 3 is a process flow chart of a control method in another embodiment. The control method in FIG. 3 is applied to the multiple computing nodes 200A˜200N of the micro-server 200 in FIG. 1. The steps S602˜S608 of the control method in FIG. 3 are the same as the steps S502˜S508 in FIG. 2. Compared to the control method in FIG. 2, the control method in FIG. 3 includes more steps. In step S610, the second processor of the selected computing node processes the second GPIO signal and generates the second control command according to the result of processing the second GPIO signal. In the next step S612, the second processor of the selected computing node selectively conducts the data path from the second switch to one of multiple baseboard management controllers according to the second control command.

In an embodiment, in step S606 in FIG. 3, the processing result of the first GPIO signal includes a code. The first processor 122 distinguishes the selected computing node by the code and generates the first control command. In step S610, the processing result of the second GPIO signal also includes the same code. The second processor distinguishes one of multiple management controllers by the code and generates the second control command.

As set forth above, the disclosure provides a control device and a control method. By a processor changing a switch, a host device can connect to the computing node of micro-servers which is to access. Also, the host device connects to the baseboard management controller which is to access of the computing node further. Therefore, although every baseboard management controllers has the same address, the host device still can access a specific baseboard management controller.

What is claimed is:

1. A control circuit board, comprising:
a host device providing a first general purpose input/output (GPIO) signal;
a first switch electrically connected to the host device; and
a first processor electrically connected to the first switch and the host device, processing the first GPIO signal, generating a first control command according to a result of processing the first GPIO signal, and selectively conduct a data path from the first switch to one of a plurality of computing nodes of a micro-server according to the first control command.

2. The control circuit board according to claim 1, wherein the result of processing the first GPIO signal includes a code, the first processor distinguishes one of the plurality of computing nodes and generates the first control command according to the code.

3. A micro-server, comprising:
a plurality of computing nodes of the micro-server, wherein each of the plurality of computing nodes comprises:
a plurality of baseboard management controllers;
a second switch electrically connected to the plurality of baseboard management controllers; and
a second processor electrically connected to the second switch, processing a second GPIO signal, generating a second control command according to a result of processing the second GPIO signal, and selectively conducting a data path from the second switch to one of the plurality of baseboard management controllers.

4. The micro-server according to claim 3, wherein the result of processing the second GPIO signal includes a code, the second processor distinguishes one of the plurality of baseboard management controllers and generates the second control command according to the code.

5. A control system, comprising:
a host device providing a first GPIO signal;
a micro-server with a plurality of computing nodes;
a first switch electrically connected to the plurality of computing nodes of the micro-server and the host device; and
a first processor electrically connected to the plurality of computing nodes of micro-servers, the host device and the first switch, processing the first GPIO signal, generating a first control command according to a result of processing the first GPIO signal, selectively conducting a data path from the first switch to one of the plurality of computing nodes of micro-servers according to the first command, and sending a second GPIO signal to one of the plurality of computing nodes, wherein each of the plurality of computing nodes comprises:
a plurality of baseboard management controllers;
a second switch electrically connected to the plurality of baseboard management controllers and the first switch; and
a second processor electrically connected to the first processor and the second switch, processing a second GPIO signal, generating a second control command according to a result of processing the second GPIO signal, and selectively conducting a data path from the second switch to one of the plurality of baseboard management controllers.

6. The control system according to claim 5, wherein the result of processing the first GPIO signal includes a code, the first processor distinguishes one of the plurality of computing nodes of micro-servers and generates the first control command according to the code.

7. The control system according to claim 6, wherein the result of processing the second GPIO signal includes the code, the second processor distinguishes one of the plurality of baseboard management controllers and generates the second control command according to the code.

8. A control method applied to a plurality of computing nodes of a micro-server, wherein each the computing node comprises a plurality of baseboard management controllers, and the control method comprises:
selecting one of the plurality of computing nodes;
providing a first GPIO signal according to the selected computing node;
processing the first GPIO signal and generating a first command according a result of processing the first GPIO signal; and
conducting a data path from a first switch to the selected computing node and delivering a second GPIO signal to the selected computing node by a electrical path.

9. The control method according to claim 8, further comprising:
processing the second GPIO signal and generating a second command according a result of processing the first GPIO signal; and
selectively conducting a data path from a second switch to one of the plurality of baseboard management controllers.

10. The control method according to claim 9, wherein the result of processing the first GPIO signal includes a code, a first processor distinguishes the selected computing node and generates a first control command according to the code, the result of processing the second GPIO signal includes the code, a second processor distinguishes one of the plurality of baseboard management controllers and generates the second command according the code.
